(19) United States
(12) Patent Application Publication
(10) Pub. No.: US 2009/0298676 A1
(43) Pub. Date: Dec. 3, 2009

(54) Unimolocular Micelles Containing Metal Nanoparticles and their Use as Catalyst for Synthesis of Carbon-Carbon-Bonds

(76) Inventors: Michael Meier, Eindhoven (NL); Jean-Francois Gohy, Louvain-La-Neuve (BE); Ulrich S. Schubert, Eindhoven (NL)

Correspondence Address: FERRELLS, PLLC, P. O. BOX 312, CLIFTON, VA, 20124-1706, US

(21) Appl. No.: 12/083,997

(22) PCT Filed: Oct. 26, 2005
(86) PCT No.: PCT/EP2005/011457

§ 371 Date: Jul. 20, 2009

(51) Int. Cl. B01J 31/06

(52) U.S. Cl. 502/159

(57) ABSTRACT

Disclosed are metal nanoparticle containing unimolecular micelles comprising selected star-shaped block-copolymers. These unimolecular micelles can be used as catalysts in coupling reactions forming carbon-carbon-bonds, for example as catalysts in the Heck reaction.

This invention relates to metal nanoparticle containing unimolecular micelles comprising selected block-copolymers. These unimolecular micelles can be used as catalysts in coupling reactions forming carbon-carbon-bonds.

### BACKGROUND OF THE INVENTION

The use of metal nanoparticles as catalysts for carbon-carbon-bond formation is known. Various methods for preparation and stabilization of metal nanoparticles are described.

Chem. Mater. 2000, 12, 22-4 discloses catalytic Pd nanoparticles synthesized using a lyotropic liquid crystal polymer template. Pd nanoparticles with small diameters are formed in a polymer matrix which can be used as catalyst for Heck reaction.

JACS 2005, 127, 2125-35 discloses formation of nanoarchitectures including subnanometer Pd clusters and their use as highly active catalysts. The stabilization of clusters in several micelle morphologies, i.e. in spherical micelles and in non-spherical micelles, is described. The micelles are produced from functional polystyrene copolymer and can be used as catalyst for Heck reaction. This document does not disclose the preparation of unimolecular micelles.

In Nano Letters 2001, vol. 1 (1), 14-17 the Heck heterocoupling with a dendritic nanoreactor is described wherein Pd nanoclusters are prepared. These nanoclusters are encapsulated in PPI dendrimers. These polymers do not possess a core-shell architecture.

In JACS 1997, 119, 10116-20 the preparation of Pd colloids in block copolymer micelles is disclosed. These colloids are used for the catalysis of the Heck reaction. The Pd clusters are encapsulated in micelles of functionalized polystyrene. This document does not disclose preparation and use of unimolecular micelles.

Langmuir 2005, 21, 2408-2413 describes keggin ion mediated synthesis of hydrophobized Pd nanoparticles for multifunctional catalysis. Pd clusters are prepared which are encapsulated in octadecylamine. These are used as catalyst for Heck reaction in a hydrocarbon solvent. Pd clusters stabilized in unimolecular micelles are not disclosed.

JACS 2002, 124, 14127-14136 describes layered double hydroxide supported nanopalladium catalyst for Heck-, Suzuki-, Sosnogashira- and Stille-type coupling reactions of chlororarenes. Pd nanoparticles supported on LDH are disclosed. The Pd nanoparticles are not encapsulated in an unimolecular micelle.

In Journ. Of Molecular Catalysis A: Chemical 229 (2005), 7-12 the preparation of Pd nanoparticles in polyethylene glycol is disclosed. These can be used as efficient and recyclable catalysts for Heck reaction. The Pd clusters are stabilized in a polyethylene glycol matrix. This document does not disclose Pd clusters encapsulated in unimolecular micelles.

Langmuir 2003, 19, 7682-7684 describes PAMAM-dendrimer stabilized Pd nanoparticles as a catalyst for the Suzuki reaction. For the stabilization of the Pd nanoparticles dendrimers are applied and no polymers with core-shell architecture.

In Adv. Funct. Mater. 2004, 14 (10), 999-1004 the shape-selective synthesis of Pd nanoparticles stabilized by highly branched amphiphilic polymers is disclosed. The polymers used possess a core-shell structure but they are not defined.

Nano Letters 2003, vol. 3 (12), 1757-1760 describes synthesis, characterization and catalytic applications of a Pd-nanoparticle cored dendrimers. The Pd nanoparticles can be used as catalysts for the Heck reaction. But no unimolecular micelles are disclosed and the polymers are dendrimers possessing no core-shell structure.

Thus, from the prior art Pd nano particles with small diameters are already known as catalysts for the formation of carbon-carbon-bonds. However, the small particles are not based on the stabilization with star-shaped block copolymer structures.

Unimolecular micelles made from dendrimers are also known.

U.S. Pat. No. 5,154,853 discloses unimolecular micelles made from dendrimers consisting essentially of alkyl or alkylene groups and their preparation. The dendrimers do not possess a core-shell structure. No stabilization of nanoparticles is disclosed.

U.S. Pat. No. 5,376,690 and U.S. Pat. No. 5,516,810 disclose metallospheres and superclusters which are prepared from unimolecular micelles containing internal void areas with reactive sites capable of covalent and noncovalent bonding to metal and non-metal guests. The dendrimers forming the unimolecular micelles do not possess a core-shell structure.

From WO-A-96/03,114 and WO-A-98/08,491 lock and key unimolecular micelles are known. These include at least one engineered acceptor specifically binding a ligand. A key unimolecular micelle comprises a core molecule and a plurality of branches extending therefrom. At least one of the branches includes a shank portion extending therefrom having a terminal moiety at an end thereof for binding to a complementary acceptor of a lock unimolecular micelle. Lock and key micelles together form an unit. Unimolecular micelles with core-shell structures are not disclosed.

Star-shaped block copolymers are also disclosed in the prior art.

EP-A-156,079 discloses star-shaped polyether polyoxyethylene prepolymers and star-shaped block copolymers made therefrom. The end products are characterised by high impact resistance and high heat resistance and be used as molding resins, i.e. for the production of fibres or foams.

WO-A-03/78,489 discloses amphiphilic block copolymers, for example star-block copolymers. These comprise a biodegradable polymer covalently attached at the polymer ends to at least one hydrophilic vinyl polymer via a divalent sulfur atom. The block copolymers are used in therapeutic compositions.

WO-A-00/59,968 discloses a process for preparing graft-block copolymers which can possess a star-shape.

### SUMMARY OF THE INVENTION

It is an object of the present invention to provide a catalyst for carbon-carbon-bond formation which is cheaper and easy to synthesize.

Another object of the present invention is the provision of a highly efficient catalyst for carbon-carbon-bond formation which can be used in smaller amounts to obtain the same conversion as compared with known catalysts for these reactions.

Still another object of the present invention is the provision of a catalyst for carbon-carbon-bond formation which is based on biocompatible polymers and might be used for the synthesis of compounds applied in biological material without adversely affecting this.

Surprisingly it has been found that in unimolecular micelles of selected block-copolymers metal nanoparticles can be formed which are highly active catalysts for carbon-carbon-coupling reactions, such as Heck reaction, Suzuki-reaction, Sosnogashira-reaction and Stille-reaction.

The catalysts of this invention are made from materials which are cheaper and easier to synthesize as the materials used in the prior art and which provide at least the same results than other small metal-nanoparticle containing materials.

### DETAILED DESCRIPTION OF THE INVENTION

The present invention relates to an unimolecular micelle comprising metal nanoparticles and a star-shaped block copolymer containing at least one hydrophilic block that is prepared from monomers which result in hydrophilic polymers, preferably a hydrophilic block selected from the group consisting of polyether block, poly-N-vinyl-heterocyclic block and polyacrylic and/or polymethacrylic block comprising hydroxyl, amino, amido and/or carboxyl groups and at least one hydrophobic block that is prepared from monomers which result in hydrophobic polymers, preferably a hydrophobic block selected from the group consisting of polyester block, polyolefin block, polyacrylate and/or polymethacrylate block and polyurethane block.

The term “unimolecular” micelle as used in this specification shall mean a functional unit made from one polymer molecule being dispersed in a solvent or in a molten material, said polymer molecule bearing a core-shell architecture and therefore provide micellar properties, e.g. a different solubility of the core than the shell, without the necessary self assembly step of classical micelles. These unimolecular micelles will have a micellar structure and behavior in different solvents unlike classical micelles. The unimolecular micelles of this invention can be of different shape, for example of spherical, elliptical, cylindrical, lamellar or worm-like shape. In case of rotation symmetry a particle diameter can be determined. Typical average diameters are in the range of 1-200 nm, preferably 1-50 nm and very preferred 1-20 nm (determined via dynamic light scattering).

Star-shaped block copolymers which are used for the unimolecular micelles of this invention are polymers possessing a star-like architecture. These molecules possess a central branching portion, providing at least three branches of block copolymer units.

The star-shaped block copolymers which can be used in this invention have a structure of the general formula I or II

R¹-[(hydrophilic block)-b-(hydrophobic block)-R²]_{z} (I)

R¹-[(hydrophobic block)-b-(hydrophilic block)-(b-hydrophobic block)_{y}-R²]_{z} (II)

wherein
z is an integer of at least 3, preferably between 3 and 32 and very preferably between 3 and 8,
y is 0 or 1,
R¹ is a z-valent organic group,
R² is hydrogen, hydroxyl or an organic group, preferably hydrogen or an alkyl or aryl group,
hydrophilic block is a block that is prepared from monomers which result in hydrophilic polymers, preferably a polyether block, a poly-N-vinyl-heterocyclic block or a polyacrylic and/or polymethacrylic block comprising hydroxyl, amino, amido and/or carboxyl groups,
hydrophobic block is a block that is prepared from monomers which result in hydrophobic polymers, preferably a polyester block, a polyolefin block, a polyacrylate and/or polymethacrylate block and/or a polyurethane block, and
b is a two-valent to penta-valent linker, preferably a two-valent linker, between the hydrophilic group and the hydrophobic group, preferably a covalent bond, a bivalent hydrocarbon group, an ester group, an ether group or an amide group.

Structures of formula I are preferred.

The hydrophilic blocks are prepared from monomers which result in hydrophilic polymers. These hydrophilic polymers can be derived from one or more monomers. (homopolymer blocks or copolymer blocks). The term “hydrophilic” as used in this description means a homo- or copolymer with a water solubility of the hydrophilic blocks of at least 100 g/L, preferably at least 200 g/L, especially preferred 300 g/L at 25° C.

The hydrophobic blocks are prepared from monomers which result in hydrophobic polymers. These hydrophobic polymers can be derived from one or more monomers. (homopolymer blocks or copolymer blocks). The term “hydrophobic” as used in this description means a homo- or copolymer with a water solubility of the hydrophobic blocks of less than 100 g/L, preferably less than 50 g/L, especially preferred less than 25 g/L at 25° C.

Preferably the hydrophilic blocks are polyether blocks, very preferably polyalkylene glycol blocks, especially preferred polyethylene glycol blocks.

Other preferred hydrophilic blocks are derived from N-vinyl-heterocyclic compounds, such as N-vinylpyridine, N-vinylpyrrolidone or N-vinylimidazole.

Other preferred hydrophilic blocks are derived from acrylic acid and/or methacrylic acid and/or their hydrophilic modified esters or amides carrying hydroxyl, amino, amido and/or carboxyl groups which blocks optionally contain co-units derived from vinylpyridine comonomers. Examples of these monomers are acrylic acid, methacrylic acid, hydroxyethylmethacrylic acid, acrylamide or methacrylamide.

Preferably the hydrophobic blocks are polyester blocks, preferably derived from aliphatic and/or aromatic dicarboxylic acids and aliphatic alcohols or from lactones, preferably from caprolactone.

Other preferred hydrophobic blocks are derived from ethylenically unsaturated hydrocarbons, such as from alpha-olefins, for example from ethylene or propylene, or from vinylaromatic compounds, such as styrene.

Other preferred hydrophobic blocks are derived from acrylic esters and/or methacrylic esters, preferably from alkylacrylates and/or alkylmethacrylates or their cycloalkyl derivatives, such as butylacrylate, methylmethacrylate, hexylacrylate, cyclohexyl(meth)acrylate or isobornyl(meth)acrylate.

Still other preferred hydrophobic blocks are derived from diisocyanates and diols to form polyurethane blocks, preferably from aliphatic or aromatic diisocyanates and aliphatic diols.

The hydrophilic blocks and/or hydrophobic blocks can be made from homopolymers or from copolymers.

Preferred star-shaped block copolymers which can be used in this invention have a structure of the general formula III or IV

R¹-[((PE)-b-(PES))ₓ—R²]_{z} (III)

R¹-[((PES)-b-(PE))ₓ-(b-PES)_{y}-R²]_{z} (IV)

wherein
PE is a polyether block, preferably with 2-100 recurring polyether units, very preferably 2-30 recurring polyether units,
PES is a polyester block, preferably with 1-100 recurring polyester units, very preferably 2-30 recurring polyester units,
x is an integer of at least 1, preferably between 1 and 30,
y is 0 or 1, and
R¹, R², b and z are as defined above.

Examples of polyether blocks are recurring units of formula V

(—O—R³)ₐ— (V)

wherein a is an integer of at least 2, very preferably from 2 to 30, and
R³ is an alkylene, cycloalkylene, arylene or aralkylene-group, preferably an alkylene group possessing two to six carbon atoms.

The PE block may be linked via its oxygen atom or a carbon atom to the group R¹. Different linking groups can be present between R¹ and PE. Examples thereof are covalent bonds, ether groups or ester groups.

Examples of polyester blocks are recurring units of formula VIa or VIb

(—R⁴—COO)_{b}— (VIa)

(—R⁵—COO—R⁶—COO)_{c}— (VIb)

wherein b and c independently of one another are integers of at least 1, very preferably from 2 to 30,
R⁴, R⁵ and R⁶ independently of one another are alkylene, cycloalkylene, arylene or aralkylene-groups, preferably an alkylene groups possessing two to six carbon atoms.

The PES group may be linked via its oxygen atom or a carbon atom to the group R¹. Different linking groups can be present between R¹ and PES. Examples thereof are covalent bonds, amine groups, ester groups or amide groups.

Preferred groups R¹ are derived from trimethylolpropane, glycerol, pentaerythrite, dipentaerythrite, carbohydrates, such as glucore, mannose or fructose, or sorbitol, trimesic acid, ethylenediaminetetraacetic acid and diamino-polyalkyleneimines, preferably H₂N—CH₂—CH₂—NH—CH₂—CH₂—NH₂.

The star-shaped block copolymers used to form the unimolecular micelles of this invention can be prepared by methods known to those skilled in the art. Their synthesis is, for example, disclosed in JACS 2004, 126, p. 11517-21.

The unimolecular micelles of this invention stabilize metal nanoparticles which can be obtained by adding to a solution containing the unimolecular micelles a solution of a metal salt. The metal salt is incorporated into the core of the unimolecular micelles by adding said salt to the liquid containing said unimolecular micelles and the metal salt is subsequently reduced to form stabilized metal nanoparticles within the unimolecular micelle.

As solvents for forming the unimolecular micelles to be used in this invention organic solvents, for example benzene, toluene, chlorotoluene or chloroform can be used. Preferably polar, aprotic organic solvents are used, for example dimethylsulfoxide, dimethylformamide or dimethylacetamide.

In general each metal including metal alloys (hereinafter together called “metals”) can be chosen for incorporation into the unimolecular micelles of this invention. Non limiting examples are metals of groups IB-VIIIB of the Periodic Table of Elements, preferably metals of the group IB and VIIIB of the Periodic Table of Elements. Preferably platinum, palladium, gold, silver, nickel or iron are used. Mixtures of different metals can also be used.

The metals are present as nanoparticles within the core (=the central portion) of the unimolecular micelles. Typical mean particle diameters of the metal nanoparticles are in a range between 1 nm and 100 nm, preferably 1 nm-10 nm, very preferably between 1 and 5 nm. The mean particle diameter is determined via TEM measurements.

Very preferably metal nanoparticles are incorporated into the unimolecular micelle of this invention, which catalyse the formation of covalent carbon-carbon bonds. A typical example of such a reaction is the Heck reaction.

A specific feature of the metal nanoparticles used in this invention for catalysis is their high surface to volume ratio. This feature is regarded to promote the catalytic action as it is believed that the reaction is taking place on the metal surface of the particles.

The incorporation of metal nanoparticles into the unimolecular micelles of this invention can be obtained by treating a unimolecular micelle containing solution with the solution of a metal salt of the metal to be deposited within the unimolecular micelles. After this treatment the metal is generated by reduction of the metal salt.

Typical examples of metal salts are acetates or chlorides, such as palladium acetate or palladium chloride. Typical examples of reducing agents are NaBH₄, LiAlH₄ or NaAlH₄.

This invention also relates to the use of the metal nanoparticles stabilized within unimolecular micelles as catalysts in a reaction for the formation of covalent carbon-carbon bonds.

The following Examples illustrate the invention without any limitation.

### EXAMPLES

5-arm star-shaped block copolymers of the following structure were prepared

R¹²—[(R¹³—O)ₗ—(OC—R¹⁴—O)ⱼ]ₖ—R¹⁵,

wherein
R¹² is a pentavalent group derived from H₂N—CH₂—CH₂—NH—CH₂—CH₂—NH₂,
R¹³ is ethylene,
R¹⁴ is pentamethylene,
R¹⁵ hydrogen,
k is 5,
l has an average value of 9, and
j has an average value between 1 and 18.

These 5-arm star-shaped block copolymers were used to stabilize palladium nanoparticles in the following way:

The poly(ethylene glycol) core was swelled with palladium acetate (Pd(CH₃COO)₂) in N,N-dimethylformamide (DMF) for 24 hours and well-defined Pd nanoparticles (about 3 nm diameter as determined by TEM (transmission electron microscopy)) were further obtained after reduction with NaBH₄. These nanoparticles were utilized for Heck C—C-coupling reactions between 4-bromo-acetophenone and styrene to form 1-[4-((E)-Styryl)-phenyl]-ethanone in high yields with low catalyst loadings. More specifically, palladium nanoparticles stabilized by block copolymers with R¹² being a pentavalent group derived from N*1*-(2-Aminoethyl)-ethane-1,2-diamine, R¹³ being ethylene, R¹⁴ being pentamethylene, R¹⁵ being hydrogen, k being 5, l having an average value of 9, and j having an average value between 0 and 18, and possessing a palladium loading of 1 Pd per 4 ethylene oxide repeat units applying a 2-fold excess of NaBH₄ according to Pd for the reduction all provided 100% conversion for the above mentioned reaction within 24 hours reaction time at 100° C. in N—N-dimethylformamide as the solvent with a Pd content of 0.1 mol %.

What is claimed is:

1. An unimolecular micelle comprising metal nanoparticles and a star-shaped block copolymer containing at least one hydrophilic block that is prepared from monomers which result in hydrophilic polymers and at least one hydrophobic block that is prepared from monomers which result in hydrophobic polymers.

2. An unimolecular micelle according to claim 1, wherein the hydrophilic block is selected from the group consisting of polyether block, poly-N-vinyl-heterocyclic block and polyacrylic and/or polymethacrylic block comprising hydroxyl, amino, amido and/or carboxyl groups and wherein the hydrophobic block is selected from the group consisting of polyester block, polyolefin block, polyacrylate and/or polymethacrylate block and polyurethane block.

3. An unimolecular micelle according to claim 1, wherein the star-shaped block copolymers have a structure of the general formula I or II
R¹-[(hydrophilic block)-b-(hydrophobic block)-R²]_{z} (I)
R¹-[(hydrophobic block)-b-(hydrophilic block)-(b-hydrophobic block)_{y}-R²]_{z} (II)
wherein
z is an integer of at least 3,
y is 0 or 1,
R¹ is a z-valent organic group,
R² is hydrogen, hydroxyl or an organic group, preferably hydrogen or an alkyl or aryl group,
hydrophilic block is a block that is prepared from monomers which result in hydrophilic polymers, preferably a polyether block, a poly-N-vinyl-heterocyclic block or a polyacrylic and/or polymethacrylic block comprising hydroxyl, amino, amido and/or carboxyl groups,
hydrophobic block is a block that is prepared from monomers which result in hydrophobic polymers, preferably a polyester block, a polyolefin block, a polyacrylate and/or polymethacrylate block and/or a polyurethane block, and b is a two-valent to penta-valent linker between the hydrophilic group and the hydrophobic group, preferably a covalent bond, a bivalent hydrocarbon group, an ester group, an ether group or an amide group.

4. An unimolecular micelle according to claim 3, wherein the star-shaped block copolymers have a structure of the general formula III or IV
R¹-[((PE)-b-(PES))ₓ-R²]_{z} (III)
R¹-[((PES)-b-(PE))ₓ-(b-PES)_{y}-R²]_{z} (IV)
wherein
PE is a polyether block,
PES is a polyester block,
x is an integer of at least 1,
y is 0 or 1, and
R¹, R², b and z are as defined in claim 3.

5. An unimolecular micelle according to claim 4, wherein the polyether blocks are recurring units of formula V
(—O—R³)ₐ— (V)
wherein a is an integer of at least 2, preferably from 2 to 30, and
R³ is an alkylene, cycloalkylene, arylene or aralkylene-group, preferably an alkylene group possessing two to six carbon atoms.

6. An unimolecular micelle according to claim 4, wherein the polyester blocks are recurring units of formula VIa or VIb
(—R⁴—COO)_{b}— (VIa)
(—R⁵—COO—R⁶—COO)_{c}— (VIb)
wherein b and c independently of one another are integers of at least 1, and
R⁴, R⁵ and R⁶ independently of one another are alkylene, cycloalkylene, arylene or aralkylene-groups, preferably an alkylene groups possessing two to six carbon atoms.

7. An unimolecular micelle according to claim 3, wherein the groups R¹ are derived from trimethylolpropane, glycerol, pentaerythrite, dipentaerythrite, carbohydrates, sorbitol, trimesic acid, ethylenediaminetetraacetic acid and diamino-polyalkyleneimines.

8. An unimolecular micelle according to claim 7, wherein the groups R¹ are derived, from H₂N—CH₂—CH₂—NH—CH₂—CH₂—NH₂.

9. An unimolecular micelle according to claim 1, wherein the metal is a metal of groups IB-VIIIB of the Periodic Table of Elements, preferably a metal of the group IB and VIIIB of the Periodic Table of Elements or mixtures thereof.

10. An unimolecular micelle according to claim 8, wherein the metal is platinum, palladium, gold, silver, nickel or iron.

11. An unimolecular micelle according to claim 1, wherein the metal nanoparticles possess mean particle diameters in a range between 1 nm and 100 nm, preferably 1 nm-10 nm, very preferably between 1 and 5 nm.

12. Use of the unimolecular micelles according to claim 1 as catalysts in a reaction for the formation of covalent carbon-carbon bonds.
